(19) United States
(12) Patent Application Publication
(10) Pub. No.: US 2013/0312471 A1
(43) Pub. Date: Nov. 28, 2013

(54) METHOD FOR OBTAINING A SOLID FERTILIZER AND BIOFUEL PRODUCT FROM SUGARCANE VINASSES AND SOLID FERTILIZER AND BIOFUEL PRODUCT OBTAINED BY MEANS OF SAID METHOD

(71) Applicant: Ignacio Martinez Garmendia, Getxo (ES)

(72) Inventor: Ignacio Martinez Garmendia, Getxo (ES)

(73) Assignee: HPD PROCESS ENGINEERING, S.A., Getxo (Vizcaya) (ES)

(21) Appl. No.: 13/988,914

(22) PCT Filed: Nov. 22, 2010
(86) PCT No.: PCT/ES2010/070757

§ 371 Date: Aug. 9, 2013

(51) Int. Cl. C05F 5/00

(52) U.S. Cl. CPC C05F 5/006
USPC 71/23; 44/605

(57) ABSTRACT

The present invention relates to a method for obtaining a solid fertilizer and biofuel product from sugarcane vinasses and solid fertilizer and biofuel product obtained by means of said method which allows optimum use of resources and high energy efficiency throughout the method, in addition to a solution for managing the residue constituted by vinasse, comprising a step A consisting of concentrating liquid vinasse (1) until obtaining concentrated vinasse (2) with a percentage of solid of at least 50%, a step B consisting of mixing the concentrated vinasse (2) with plant compounds (3), and a step C consisting of granulating the mixture obtained in step B until obtaining a solid granulated product (4) that can be used as fertilizer (4′) and as biofuel (4″).

### TECHNICAL FIELD OF THE INVENTION

The present invention has an application in the process industry, and more specifically in the field of agrochemical industry, which allows obtaining a solid fertilizer product that can also be used as biofuel from sugarcane vinasses, which leads to optimum use of resources and high energy efficiency throughout the method, in addition to a solution to the problem of managing residues constituted by the generation of vinasse in sugarcane juice fermentation and distillation processes.

### BACKGROUND OF THE INVENTION

Sugarcane vinasse is a liquid product obtained in the process of obtaining alcohol from sugarcane juices or molasses. Molasses or juice is a dark brown, very sweet liquid of certain viscosity that is obtained during the process of producing sugar from sugarcane.

In said process of producing sugar from sugarcane, the raw material is first crushed to extract its juice or molasses, leaving bagasse as a residue. Said juice in turn has a high sugar content and can be used in two alternative ways. On one hand, the juice can be concentrated to obtain granulated sugar. On the other hand, said juice can be intended for alcohol production, for which the juice is fermented giving rise to wines which are introduced in distillation columns where alcohol is obtained and a liquid residue, i.e., vinasse, remains.

These vinasses are an acidic residue (pH=4.2-4.6) with a high dissolved organic matter content and with a level of inorganic matter greater than that of other vinasses from cereals or yeasts, for example, which is the reason sugarcane vinasse is a potent contaminant the management of which is becoming a serious problem in alcohol distilleries given that between approximately 10-15 liters of vinasse, which is a very large amount of residue, are generated for each liter of alcohol produced.

In order to solve this problem, different processes having the common objective of recovering sugarcane vinasse are known today. In this sense, mention must be made of processes comprising methanization followed by reverse osmosis which have a high operating cost, or processes comprising composting in which large surfaces are required, in addition to having maintenance problems, among which the presence of microorganisms and the generation of foul odors are included.

Likewise, techniques for recovering sugarcane vinasse which comprise the operations of mixing with other products in order to produce a solid fertilizer product are also known. In this sense, there are various products today which are obtained from sugarcane vinasse and are marketed as fertilizers.

However, one of the problems that arises today in obtaining said fertilizers is that it is necessary to add inert compounds, such as clays, for example, to act as binding means in order to provide the obtained product with consistency and homogeneity, such that it allows subsequent granulation. The presence of said binders constitutes a drawback from the process energy efficiency viewpoint since the obtained surplus product cannot be reused in any other way than as a fertilizer given that the binders lack calorific value, which makes obtaining energy from the obtained solid product unviable since, in addition to reducing the calorific value of the product, the binders would cause various problems during combustion.

### DESCRIPTION OF THE INVENTION

A first aspect of the present invention relates to a method for obtaining a solid fertilizer and biofuel product from sugarcane vinasses which is a novel solution to the aforementioned problem of managing vinasses produced as a residue while obtaining alcohol from sugarcane.

By means of the method of the invention, vinasse is converted into a product with a high agricultural value, such as a fertilizer, and which is also a biofuel from which energy can be recovered to compensate for the operating cost of the entire method, the overall result of which is the conversion of an environmental problem into a sustainable and ecological process for obtaining an added value product using the chemical composition and energy potential thereof.

To that end, the method proposed by the invention comprises a step A consisting of concentrating liquid vinasse generated as liquid residue in a process of obtaining alcohol from sugarcane until obtaining concentrated vinasse with a percentage of solid of at least 50%.

Next, the method comprises a step B consisting of mixing the concentrated vinasse obtained in step A with plant compounds, and then a step C consisting of granulating the mixture obtained in step B until obtaining a solid granulated product that can be used as a fertilizer and as a biofuel.

The method allows obtaining a biofuel product from vinasse and other natural residues such as bagasse or ash that can be incinerated, with the subsequent energy recovery this entails. Likewise, by means of the method a fertilizer with a high agricultural value is obtained from said byproducts of producing alcohol from sugarcane, whereby an integral vinasse treatment process is achieved with operating cost minimization as a result of integrating the processes.

The possibility that step A is performed in an evaporator until obtaining concentrated vinasse with a percentage of solid substantially equal to 60% is contemplated. It is likewise contemplated that in step B the concentrated vinasse is mixed with bagasse obtained in a sugarcane crushing phase in the process of obtaining alcohol from sugarcane.

It is likewise contemplated that after step C the method comprises a step D consisting of incinerating solid product used as biofuel, ash used for mixing in step B, and energy harnessed to perform the evaporation of step A and the mixing of step B, being obtained.

According to a preferred embodiment of the invention, the method combines different technologies, such as concentrating, preferably by means of evaporation, mixing with plant compounds, granulating the mixture and incinerating the obtained solid product, i.e., the granulate, under the principles of minimizing economic and environmental impact since byproducts are not generated and emissions are controlled within the levels established by the law in force.

Up to 60% of the vinasse is concentrated into solids in an evaporator, subsequently mixed with plant components, mainly dry and ground sugarcane bagasse, granulated and finally part of that granulate is incinerated. In this last step, sufficient energy is generated for powering the evaporation and drying processes and ash that can be used in the granulate is generated. The non-incinerated granulate is a fertilizer that can be used as manure.

Therefore, unlike fertilizers obtained by means of methods known today, the fertilizer is obtained without binders. The development of a granulated product without the need for binders using only bagasse is novel and involves a huge advance providing technical viability to the burning and energy recovery thereof.

Sugarcane vinasse evaporation is a very complex process given the chemical composition of vinasses with components having a high scaling ability. This along with the high viscosity of the product at high concentrations gives rise to installations with a low yield, scarce availability and various operating problems.

In turn, according to a preferred embodiment, the method of the invention is carried out in a plant with EHSC (Enhanced High Solids Concentrator) technology, whereby the concentration necessary to enable granulating the concentrate with extended periods of availability without scaling and with lower operating consumptions is achieved, opening up new perspectives in the field of vinasse concentration.

The technology used in vinasses up until now did not allow achieving the final solid concentration required for the process and still ensuring reasonable cleaning periods, so the use of the technology mentioned in the preceding paragraph is vital to complete the process of the invention, the differences of which with the existing technology can be summarized in that the equipment used for the method of the invention are forced circulation evaporators with turbulence promoters inside the tubes (Enhanced High Solids Concentrator), which improve equipment efficiency by reducing electricity consumption and allowing obtaining higher concentrations despite the high viscosity reached by the product. Its suitability for such vinasse also resides in that since it works like a crystallizer, it allows working with suspended solid without this negatively affecting the transfer surface.

In contrast, evaporators used up until now have serious scaling due to salt precipitation, mainly calcium salt precipitation, the availability thereof is very low and the necessary concentrations, 60% of solids, for obtaining the product object of the method of the invention, are not reached.

To granulate the vinasse, compounds which allow binding the concentrate and forming a cake which is dried for subsequent granulate manufacture, must be added. Part of those additives are generally compounds with low or zero calorific value which could cause problems in a hypothetical incineration. According to a preferred embodiment, it has been confirmed that a product formulation from about 60% of vinasse to 60-65% of solids and 40% of ground bagasse with a moisture content not greater than 5% allows granulating the concentrated vinasse with natural additives making the subsequent burning thereof viable.

The granulate burning process is a process that respects the environmental emission limits and provides energy recovery in a steam boiler. The energy necessary to reduce the process operating cost to a minimum is thus obtained.

A second aspect of the present invention relates to a solid fertilizer and biofuel product obtained by means of a method such as the one described above.

### DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting character:

FIG. 1 shows a block diagram of the method object of the invention.

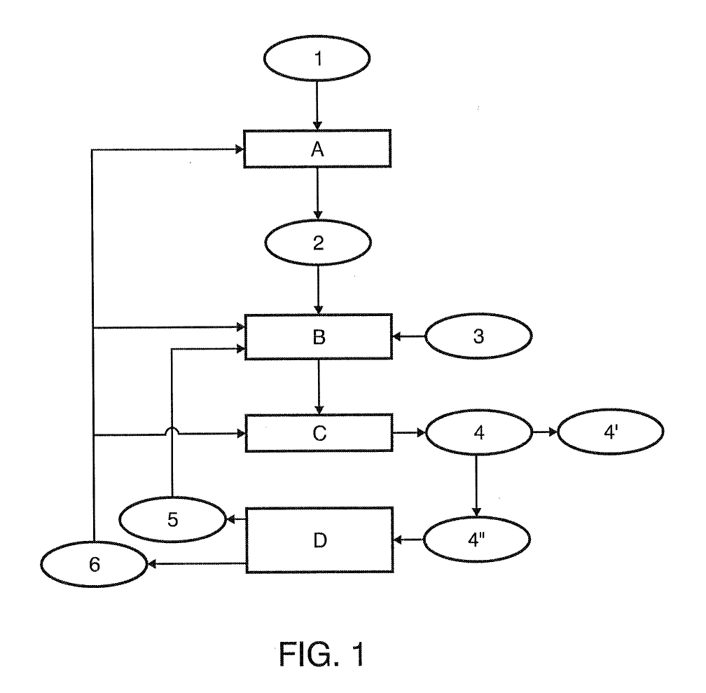

### PREFERRED EMBODIMENT OF THE INVENTION

In view of the mentioned drawing, it can observed how in one of the possible embodiments of the invention the method for obtaining a solid fertilizer and biofuel product from sugarcane vinasses proposed by the invention comprises a step A which is performed in an evaporator and consists of concentrating liquid vinasse (1) generated as liquid residue in a process of obtaining alcohol from sugarcane until obtaining concentrated vinasse (2) with a percentage of solid of 60%.

Next, the method comprises a step B consisting of mixing the concentrated vinasse (2) obtained in step A with bagasse (3) obtained in a sugarcane crushing phase, and then a step C consisting of granulating the mixture obtained in step B until obtaining a solid granulated product (4) that can be used as a fertilizer (4′) and as a biofuel (4″).

After step C the method comprises a step D consisting of incinerating solid product (4) used as a biofuel (4″), ash (5) used for mixing in step B, and energy (6) harnessed to perform the evaporation of step A and the mixing of step B, being obtained.

The following block diagram illustrates the process that starts from the liquid vinasse (1) generated in alcohol production.

Up to 60% of the liquid vinasse (1) is therefore concentrated into solids in the evaporator, subsequently mixed with dry and ground sugarcane bagasse (3), granulated and finally part of that granulate is incinerated. In this last step, sufficient energy (6) is generated for powering the evaporation and drying processes and ash (5) that can be used in the granulate is generated. The non-incinerated granulate is a fertilizer that can be used as manure.

A second aspect of the present invention relates to a solid fertilizer and biofuel product obtained by means of a method such as the one described above.

A characterization of the obtained solid product (4) according to a preferred embodiment is indicated below:

| Total nitrogen (N) | 1.14% | |
|---|---|---|
| Total phosphorus (P₂O₅) | 0.17% | |
| Total potassium (K₂O) | 6.17% | |
| Soluble potassium (K₂O) | 5.47% | |
| Total calcium (CaO) | 2.92% | |
| Total magnesium (MgO) | 1.01% | |
| Total sulfur (S) | 1.25% | |
| Total copper (Cu) | 35.43 | ppm |
| Total iron (Fe) | 0.50% | |
| Total zinc (Zn) | 285.40 | ppm |
| Total manganese (Mn) | 298.11 | ppm |
| Total boron (B) | 0.35 | ppm |
| Total sodium (Na) | 0.16% | |
| Oxidizable organic carbon (C) | 29.91% | |
| Total silicon (SiO₂) | 6.39% | |
| pH (Saturated paste) | 4.79 | |
| E.C. (Saturated paste) | 12.44 | dS/m |

| | |
|---|---|
| Moisture (70° C. × 24 h) | 5.60% |
| Apparent density (g/mL) | 0.4755 |
| C.E.C. (me/100 g) | 34.00 |
| Ash (650° C. × 4 h) | 25.91% |
| Losses by volatilization | 74.09% |
| Moisture retention | 83.26% |
| Insoluble residues | 31.63% |
| C/N ratio | 26.24 |

In view of this description and set of drawings, the person skilled in the art will understand that the embodiments of the invention which have been described can be combined in many ways within the object of the invention. The invention has been described according to several preferred embodiments thereof, but for the person skilled in the art it will be evident that multiple variations can be introduced in said preferred embodiments without exceeding the object of the claimed invention.

1. Method for obtaining a solid fertilizer and biofuel product from sugarcane vinasses, characterized in that it comprises:
a step A consisting of concentrating liquid vinasse (1) generated as liquid residue in a process of obtaining alcohol from sugarcane until obtaining concentrated vinasse (2) with a percentage of solid of at least 50%,
a step B consisting of mixing the concentrated vinasse (2) obtained in step A with plant compounds (3), and
a step C consisting of granulating the mixture obtained in step B until obtaining a solid granulated product (4) that can be used as fertilizer (4′) and as biofuel (4″).

2. Method according to claim 1, wherein step A is performed in an evaporator until obtaining concentrated vinasse (2) with a percentage of solid substantially equal to 60%, and wherein in step B the concentrated vinasse (2) is mixed with bagasse (3) obtained in a sugarcane crushing phase in the process of obtaining alcohol from sugarcane.

3. Method according to claim 1, where after step C it comprises a step D consisting of incinerating solid product (4) used as biofuel (4″), ash (5) used for mixing in step B, and energy (6) harnessed to perform the evaporation of step A and the mixing of step B, being obtained.

4. Solid fertilizer and biofuel product obtained by means of a method according to claim 1.

5. Method according to claim 2, where after step C it comprises a step D consisting of incinerating solid product (4) used as biofuel (4″), ash (5) used for mixing in step B, and energy (6) harnessed to perform the evaporation of step A and the mixing of step B, being obtained.
